(19) United States
(12) Patent Application Publication
(10) Pub. No.: US 2014/0108835 A1
(43) Pub. Date: Apr. 17, 2014

(54) POWER MANAGEMENT INTEGRATED CIRCUIT AND OPERATING METHOD THEREOF

(71) Applicant: Samsung Electronics Co., Ltd., Suwon-Si (KR)

(72) Inventors: Sang-Yong PARK, Suwon-si (KR); Jekook KIM, Yongin-si (KR); Chan-Woo PARK, Anyang-si (KR); Younghoon LEE, Seoul (KR)

(73) Assignee: Samsung Electronics Co., Ltd., Suwon-Si (KR)

(21) Appl. No.: 14/050,793

(22) Filed: Oct. 10, 2013

(30) Foreign Application Priority Data
Oct. 11, 2012 (KR) 10-2012-0112958

(51) Int. Cl. G06F 1/32

(52) U.S. Cl. CPC G06F 1/3275
USPC 713/320

(57) ABSTRACT

A power management integrated circuit includes a nonvolatile memory configured to store code data for driving the power management integrated circuit; a processor configured to execute program data stored at a volatile memory; and a decompression logic separated from the processor, the decompression logic being formed of hardware, configured to decompress the code data to generate program data, and configured to store the program data at the volatile memory.

### CROSS-REFERENCE TO RELATED APPLICATIONS

A claim for priority under 35 U.S.C. §119 is made to Korean Patent Application No. 10-2012-0112958 filed Oct. 11, 2012, in the Korean Intellectual Property Office, the entire contents of which are hereby incorporated by reference.

### BACKGROUND

Example embodiments of the inventive concepts described herein relate to a power management integrated circuit and a driving method thereof.

In recent years, with development of portable and small-sized electronic devices, supplying of a power to an electronic device may become an importance issue. In a System-on-Chip (SoC) in which an electronic device is integrated to a chip, integration on a power management function may be required. A power management integrated circuit (PMIC) may be used to supply a power stably to handheld electronic devices such as a cellular phone, a PDA, a PMP, a camera, and so on.

Many circuits in an electronic device may need different power supply voltages. The power management integrated circuit may be connected with a battery to generate different power supply voltages. The power management integrated circuit may power the electronic device using the different power supply voltages. Also, the power management integrated circuit may reduce power consumption of a device by adjusting a power supply voltage according to a driving state of the electronic device. As functions of the power management integrated circuit increase, size and complexity of the power management integrated circuit may increase.

### SUMMARY

According to example embodiments of the inventive concepts, a power management integrated circuit includes a nonvolatile memory configured to store code data for driving the power management integrated circuit; a processor configured to execute program data stored at a volatile memory; and a decompression logic separated from the processor, the decompression logic being formed of hardware, configured to decompress the code data to generate program data, and configured to store the program data at the volatile memory.

The decompression logic may be configured to determine whether the code data is compressed, and to decompress the code data according to a determination result, and the code data may include header data indicating whether the code data is compressed.

The decompression logic may include a compression check unit configured to determine whether the code data is compressed, based on the header data; a packet check unit configured to determine whether a packet in the code data is compressed; a packet decompression unit configured to decompress the packet when the packet is determined to be compressed; and a buffer connected with the compression check unit, the packet check unit, and the packet decompression unit and configured to store data.

The compression check unit may be configured to determine the code data to be uncompressed code data when the header data is ‘0’. The decompression logic may be configured such that if the code data is determined to be uncompressed code data, the compression check unit stores the code data at the buffer without decompression.

The packet may include a flag bit indicating whether the packet is compressed.

The decompression logic may be configured such that if the flag bit is 0, the packet check unit determines the packet to be an uncompressed packet. The decompression logic may be configured such that if the packet is determined to be an uncompressed packet, the packet check unit stores the packet at the buffer without decompression.

The code data may be compressed in a dictionary reference manner.

The packet decompression unit may be configured to, identify a dictionary address and a match length from the packet, generate a physical address using the dictionary address and the match length, and decompress the packet based on the physical address.

The nonvolatile memory may include a nonvolatile memory storage unit configured to store data; and a nonvolatile memory controller configured to control a data processing operation of the nonvolatile memory storage unit, wherein the decompression logic is included in the nonvolatile memory controller.

The volatile memory may include a volatile memory storage unit configured to store data; and a volatile memory controller configured to control a data processing operation of the volatile memory storage unit, wherein the decompression logic is included in the volatile memory controller.

According to example embodiments of the inventive concepts, a driving method of a power management integrated circuit which includes a nonvolatile memory storing code data, a processor for executing program data, and decompression logic separated from the processor and formed of hardware may include providing the code data to the decompression logic from the nonvolatile memory when the code data is requested by the processor; determining whether the code data is compressed; and if the code data is compressed, decompressing the code data to generate the program data, and storing the program data at a volatile memory.

The method may further include, if the code data is determined not to be compressed, storing the code data at the volatile memory as the program data.

The decompressing the code data to generate program data may include decompressing the code data by the packet.

According to example embodiments of the inventive concepts, a power management integrated circuit includes a nonvolatile memory storing encoded data that, when decoded, includes program data including executable instructions for driving the power management integrated circuit; a hardwired decompression logic configured to decompress the encoded data to generate the program data and to store the program data at the volatile memory; and a processor configured to execute program data stored at a volatile memory, the hardwired decompression logic being separate from the processor.

The hardwired decompression logic may include a decompression unit configured to decompress the encoded data; and a buffer connected with the decompression unit and configured to store the decompressed data.

### BRIEF DESCRIPTION OF THE FIGURES

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram schematically illustrating a power management integrated circuit according to example embodiments of the inventive concepts;

FIG. 2 is a block diagram schematically illustrating hardware decompression logic according to example embodiments of the inventive concepts;

FIG. 3 is a flow chart illustrating a packet decompressing method according to example embodiments of the inventive concepts;

FIG. 4 is a block diagram schematically illustrating a power management integrated circuit according to example embodiments of the inventive concepts;

FIG. 5 is a block diagram schematically illustrating a power management integrated circuit according to still example embodiments of the inventive concepts;

FIG. 6 is a flow chart illustrating a driving method of a power management integrated circuit according to example embodiments of the inventive concepts;

FIG. 7 is a block diagram schematically illustrating an electronic device including a power management integrated circuit according to example embodiments of the inventive concepts; and

FIG. 8 is a block diagram schematically illustrating a smart phone including a power management integrated circuit according to example embodiments of the inventive concepts.

### DETAILED DESCRIPTION

Embodiments will be described in detail with reference to the accompanying drawings. Example embodiments of the inventive concepts, however, may be embodied in various different forms, and should not be construed as being limited only to the illustrated embodiments. Rather, these embodiments are provided as examples so that this disclosure will be thorough and complete, and will fully convey example embodiments of the inventive concepts to those skilled in the art. Accordingly, known processes, elements, and techniques are not described with respect to some of the example embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

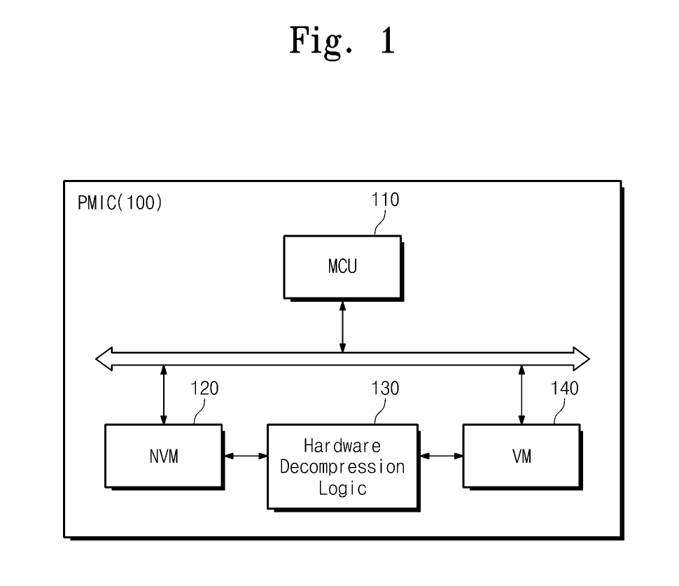

FIG. 1 is a block diagram schematically illustrating a power management integrated circuit 100 according to example embodiments of the inventive concepts. Referring to FIG. 1, a power management integrated circuit 100 may include a microprocessor (MCU) 110, a nonvolatile memory 120, hardware or hardwired decompression logic 130, and a volatile memory 140.

In example embodiments, the power management integrated circuit 100 may compress code data necessary for an operation to store it at the nonvolatile memory 120. The code data may be data needed to boot the power management integrated circuit 100, for example. In the power management integrated circuit 100, the compressed code data may be decompressed by the hardware decompression logic 130. The power management integrated circuit 100 may load the decompressed code data onto a working area of the nonvolatile memory 120. The power management integrated circuit 100 may operate based on data loaded on the working area.

The power management integrated circuit 100 may compress and use the code data. Thus, a size of the nonvolatile memory 120 at which the code data is stored may decrease. In the power management integrated circuit 100, the nonvolatile memory 120 may take a larger space compared with other components. As a size of the nonvolatile memory 120 decreases, a size of the power management integrated circuit 100 may also decrease.

The hardware or hardwired decompression logic 130 (hereinafter, the term “hardware decompression logic” is to be considered synonymous to the term “hardwired decompression logic”) may perform compression in hardware without using a decompression program. A decompression speed of the hardware decompression logic 130 may be faster than a software decompression speed using a microprocessor. Thus, it is possible to implement a small-sized and speedy power management integrated circuit 100.

The microprocessor 110 may control an overall operation of the power management integrated circuit 100. The microprocessor 110 may control the nonvolatile memory 120 and the volatile memory 140. The microprocessor 110 may include a digital signal processor (DSP). In example embodiments, the microprocessor may be used as a central processing unit. However, example embodiments of the inventive concepts are not limited thereto.

The nonvolatile memory 120 may store code data necessary for an operation of the power management integrated circuit 100. The nonvolatile memory 120 may send the code data to the hardware decompression logic 130 according to a control of the microprocessor 110. The nonvolatile memory 120 may include a phase change memory (PCM), a magnetic random access memory (MRAM), a ferromagnetic random access memory (FRAM), or a flash memory. However, example embodiments of the inventive concepts are not limited thereto.

The hardware decompression logic 130 may decompress code data provided from the nonvolatile memory 120. The hardware decompression logic 130 may send decompressed data, that is, program data to the volatile memory 140. The hardware decompression logic 130 may be formed by an independent circuit which is, for example, separate from the nonvolatile memory 120 or the volatile memory 140.

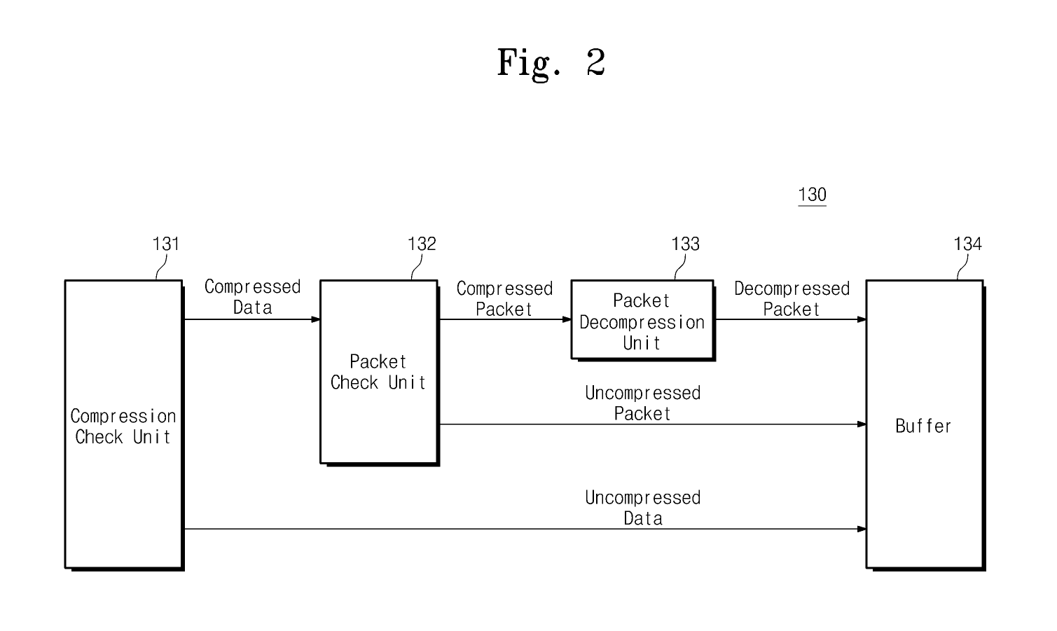

Also, the hardware decompression logic 130 may not be connected with the microprocessor 110 or a system bus. The hardware decompression logic 130 may perform a decompression operation independently without a control of the microprocessor 110. An operation of the hardware decompression logic 130 will be more fully described with reference to FIG. 2.

With respect to software decompression, according to at least some techniques, program data for a decompression program has to be stored at the nonvolatile memory 120 to decompress code data in software using the microprocessor 110. The microprocessor 110 may load program data from the nonvolatile memory 120 onto the volatile memory 140. The microprocessor 110 may fetch the loaded program data to perform decompression. Thus, software decompression on code data may necessitate operations of fetching a code and executing a program. Thus, an execution time may become long.

On the other hand, the hardware decompression logic 130 may decompress code data in hardware using a decompression program. Since the hardware decompression logic 130 is configured independently without controls of other components, it may decompress input code data without additional operations. Thus, the hardware decompression logic 130 may perform a decompression operation rapidly.

Code data decompressed by the hardware decompression logic 130 may include booting data of the power management integrated circuit 100. When a system including the power management integrated circuit 100 is powered on, it is desirable for the power management integrated circuit 100 to be booted first in the system. With example embodiments of the inventive concepts, since a booting time of the power management integrated circuit 100 is short, a booting time of a system may be shortened.

The volatile memory 140 may receive decompressed code data from the hardware decompression logic 130. The volatile memory 140 may store the decompressed code data. The microprocessor 110 may drive the power management integrated circuit 100 using data stored at the volatile memory 140. The volatile memory 140 may be a DRAM or an SRAM. However, example embodiments of the inventive concepts are not limited thereto.

FIG. 2 is a block diagram schematically illustrating hardware decompression logic 130 according to example embodiments of the inventive concepts. Referring to FIG. 2, hardware decompression logic 130 may include a compression check unit 131, a packet check unit 132, a packet decompression unit 133, and a buffer 134. A structure of the hardware decompression logic 130 may not be limited to this disclosure.

The compression check unit 131 may receive code data from a nonvolatile memory 120 (refer to FIG. 1). The compression check unit 131 may check whether the input code data is compressed, based on header data of the code data. In example embodiments, the compression check unit 131 may decide the input code data as uncompressed data when the header data is a particular value, for example, ‘0’. The compression check unit 131 may decide the input code data as compressed data when the header data is a particular value, for example, ‘1’.

The compression check unit 131 may send all packets of data decided as uncompressed data sequentially to the buffer 134. The uncompressed data may be uncompressed data of data stored at the nonvolatile memory 120. The uncompressed data may be stored at the buffer 134 without decompression.

The compression check unit 131 may send packets of data decided as compressed data sequentially to the packet check unit 132. The compressed data may be stored at the buffer 134 after decompression.

The packet check unit 132 may determine whether an input data packet is compressed. In example embodiments, a data packet may include a compression flag bit. The packet check unit 132 may decide an input data packet as an uncompressed packet when the compression flag bit is a particular value, for example, ‘0’. The packet check unit 132 may decide an input data packet as a compressed packet when the compression flag bit is a particular value, for example, ‘1’.

The packet check unit 132 may send a packet determined to be an uncompressed packet to the buffer 134. The packet check unit 132 may send a packet determined to be a compressed packet to the packet decompression unit 133.

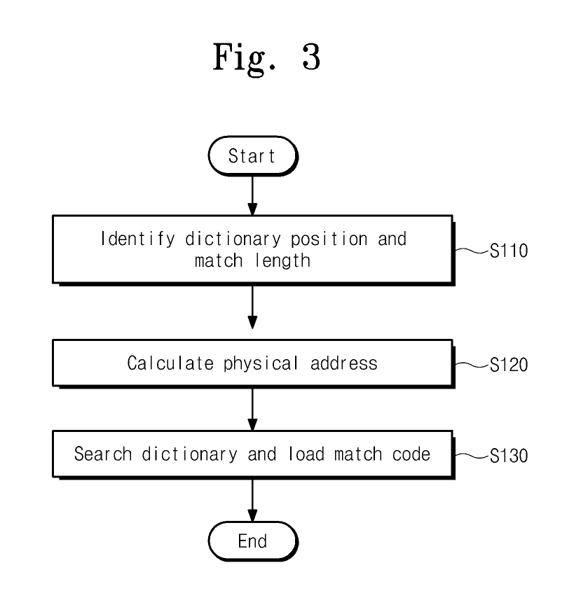

The packet decompression unit 133 may decompress an input compressed packet. The packet decompression unit 133 may send the decompressed packet to the buffer 134. A decompression method of the packet decompression unit 133 may vary according to a compression manner of code data stored at the nonvolatile memory 120. A decompression method of the packet decompression unit 133 according to example embodiments of the inventive concepts will be more fully described with reference to FIG. 3. However, example embodiments of the inventive concepts are not limited thereto.

The buffer 134 may receive uncompressed or decompressed data packets from one or more of the compression check unit 131, the packet check unit 132, and the packet decompression unit 133. If all packets of code data are received, the buffer 134 may store input data at a working area of a volatile memory 140 (refer to FIG. 1). The storing of the data may be driven by a microprocessor 140 (refer to FIG. 1).

The hardware decompression logic 130 may perform compression in hardware without using a decompression program. Since the hardware decompression logic 130 is formed by an independent circuit, the hardware decompression logic 130 may perform a decompression operation on input code data without additional operations. Thus, the hardware decompression logic 130 may perform a decompression operation rapidly.

FIG. 3 is a flow chart illustrating a packet decompressing method according to example embodiments of the inventive concepts. According to example embodiments of the inventive concepts, the hardware decompression logic 130 may operate in accordance with the method illustrated In FIG. 3 and discussed below. In example embodiments of the inventive concepts, code data may be compressed in a dictionary reference manner, and the compressed code data may be stored at a nonvolatile memory 120.

In operation S110, a dictionary position and a match length may be identified from an input compressed packet. The dictionary position may indicate a position of a dictionary corresponding to the input compressed packet. The match length may indicate a bit length corresponding to the input compressed packet.

In operation S120, a physical address at which original data is stored may be calculated from the dictionary position and the bit length.

In operation S130, a dictionary may be searched using the calculated physical address, and matched code data may be loaded on a buffer. The loaded code data may be original data before a packet is compressed.

With the packet decompressing method of FIG. 3, hardware decompression logic may decompress code data compressed in a dictionary reference manner by the packet. Since the dictionary reference manner is a lossless compression manner, the hardware decompression logic may perform decompression within a rapid time without data loss.

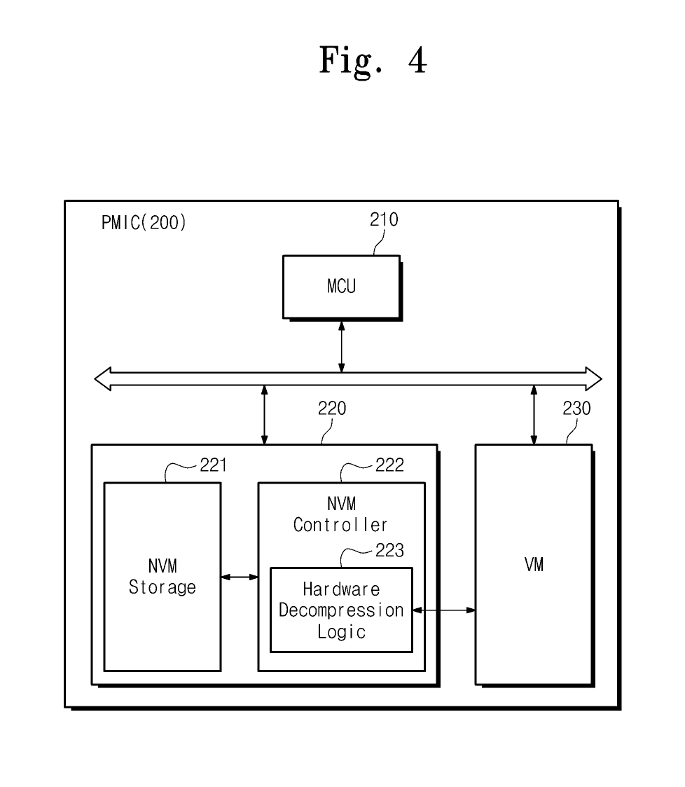

FIG. 4 is a block diagram schematically illustrating a power management integrated circuit 200 according to example embodiments of the inventive concepts. A microprocessor 210 and a volatile memory 230 of FIG. 3 may have the same configuration and operation as that described herein with respect to the microprocessor 110 and the volatile memory 140 of FIG. 1.

The nonvolatile memory 220 may include a nonvolatile memory storage unit 221 and a nonvolatile memory controller 222.

The nonvolatile memory storage unit 221 may store code data necessary for an operation of the power management integrated circuit 200. Code data stored at the nonvolatile memory storage unit 221 may be compressed in various manners.

The nonvolatile memory controller 222 may control the nonvolatile memory storage unit 221. For example, the nonvolatile memory controller 222 may control a read operation on data stored at the nonvolatile memory storage unit 221.

The nonvolatile memory controller 222 may include hardware decompression logic 223. When a data read operation is requested from the microprocessor 210, the nonvolatile memory controller 222 may read code data stored at the nonvolatile memory storage unit 221. The nonvolatile memory controller 222 may decompress the read code data using the hardware decompression logic 223. The hardware decompression logic 223 may have the same structure and operation that of the hardware decompression logic 130 described herein.

The hardware decompression logic 223 may be included in the memory controller 222, but may not be controlled by the microprocessor 210. The hardware decompression logic 223 may decompress the input code data independently to send it to the volatile memory 230.

As described above, in the power management integrated circuit 200, code data may be decompressed by the nonvolatile memory controller 222, and the decompressed code data may be sent to the volatile memory 230. Herein, code data decompressed by the nonvolatile memory controller 222 may include booting data of the power management integrated circuit 200. When a system including the power management integrated circuit 200 is powered on, it is desirable for the power management integrated circuit 200 to be booted first in the system. Since a booting time of the power management integrated circuit 200 is short, a booting time of the system may be shortened. Also, since a size of data to be stored at the nonvolatile memory storage unit 221 is reduced, a size of the power management integrated circuit 200 may be reduced.

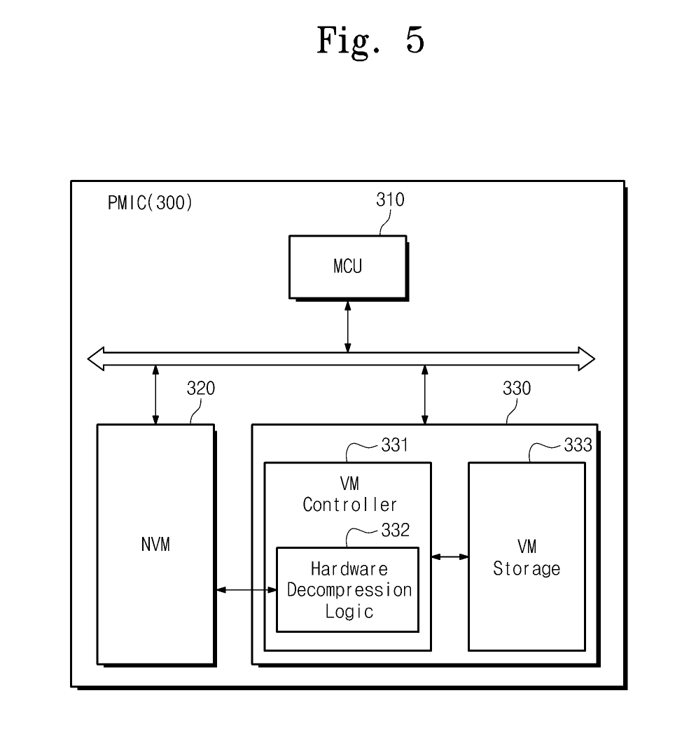

FIG. 5 is a block diagram schematically illustrating a power management integrated circuit 300 according to example embodiments of the inventive concepts. A microprocessor 310 and a nonvolatile memory 320 of FIG. 5 may have the same operation and configuration as that described herein with reference to the microprocessor 110 and a nonvolatile memory 120 of FIG. 1.

A volatile memory 330 may include a volatile memory controller 331 and a volatile memory storage unit 333.

The volatile memory controller 331 may control the volatile memory storage unit 333. For example, the volatile memory controller 331 may control a write operation of the volatile memory storage unit 333.

The volatile memory controller 331 may include hardware decompression logic 332. The hardware decompression logic 332 may have the same structure and operation that of the hardware decompression logic 130 described herein. If a data read operation is requested from the microprocessor 310, the nonvolatile memory 320 may send code data to the volatile memory 330. The volatile memory controller 331 may decompress the input code data using the hardware decompression logic 332.

The hardware decompression logic 332 may be included in the volatile memory controller 331, but may not be controlled by the microprocessor 310. The hardware decompression logic 332 may decompress the input code data independently to send it to the volatile memory storage unit 333.

As described above, in the power management integrated circuit 300, code data may be sent to the volatile memory 330. The sent code data may be decompressed by the volatile memory controller 331, and the decompressed code data may be stored at the volatile memory storage unit 333. Herein, code data decompressed by the volatile memory controller 331 may include booting data of the power management integrated circuit 300. When a system including the power management integrated circuit 300 is powered on, it is desirable for the power management integrated circuit 300 to be booted first in the system. Since a booting time of the power management integrated circuit 300 is short, a booting time of the system may be shortened. Also, since a size of data to be stored at the nonvolatile memory 320 is reduced, a size of the power management integrated circuit 300 may be reduced.

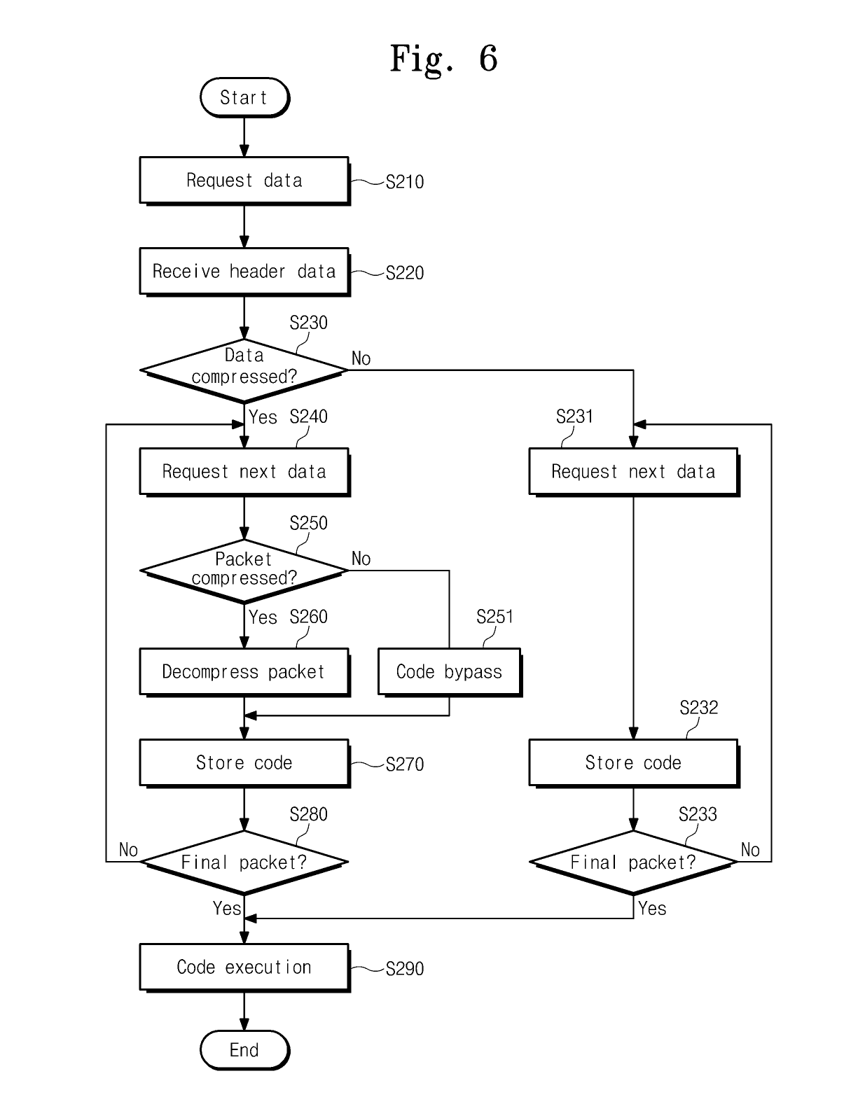

FIG. 6 is a flow chart illustrating a driving method of a power management integrated circuit according to example embodiments of the inventive concepts. Since a power management integrated circuit decompresses compressed code data in hardware, a size may be reduced and a speed may be improved. According to example embodiments of the inventive concepts, any of the PMICs 100, 200 and 300 may operate in accordance with the method illustrated in FIG. 6 and discussed below.

In operation S210, a microprocessor may request data that is stored at a nonvolatile memory. The microprocessor may request booting data of the power management integrated circuit at a system boosting operation. The nonvolatile memory may send code data to hardware decompression logic in response to a request of the microprocessor.

In operation S220, the hardware decompression logic may first receive header data of the code data.

In operation S230, the hardware decompression logic may determine whether the input code data is compressed, based on the header data. For example, the hardware decompression logic may decide the input code data as uncompressed data when the header data is ‘0’. The hardware decompression logic may decide the input code data as compressed data when the header data is ‘1’.

If the input code data is determined to be uncompressed code data, in operation S231, the hardware decompression logic may receive a data packet next to the header data.

In operation S232, the hardware decompression logic may store the input data at a buffer. The above-described data storing procedure may be repeated until a last packet of the code data is received (S233).

If the input code data is determined to be compressed code data, in operation S240, the hardware decompression logic may receive a data packet next to the header data.

In operation S250, the hardware decompression logic may determine whether the input packet is compressed. For example, the hardware decompression logic may decide an input packet as an uncompressed packet when a compression flag bit is ‘0’. The hardware decompression logic may decide an input packet as a compressed packet when the compression flag bit is ‘1’.

In operation S251, if the input packet is determined to be an uncompressed packet, the hardware decompression logic may store the packet at the buffer without decompression (S270).

In operation S260, if the input packet is determined to be a compressed packet, the hardware decompression logic may decompress the packet to store it at the buffer (S270). A code data compression manner may be a dictionary reference manner. In operation S260, the hardware decompression logic may identify a dictionary position and a match length on the input packet to decompress the packet.

In operation S280, a process in which whether the packet is compressed is determined, the packet is decompressed, and the decompressed data is stored at the buffer may be repeated until a last packet of the code data is received.

If a last packet is stored at the buffer, the method proceed to operation S290. In operation S290, the hardware decompression logic may store the decompressed code data at a working area of a volatile memory. The stored code data may be driven by the microprocessor.

As described above, in the driving method of the power management integrated circuit, compressed code data may be stored at the nonvolatile memory. Thus, since a size of data to be stored at the nonvolatile memory is reduced, a size of the power management integrated circuit may be reduced. Also, since compressed code data is decompressed in hardware, a booting time of the power management integrated circuit may be shortened. This may mean that a booting time of the system is shortened.

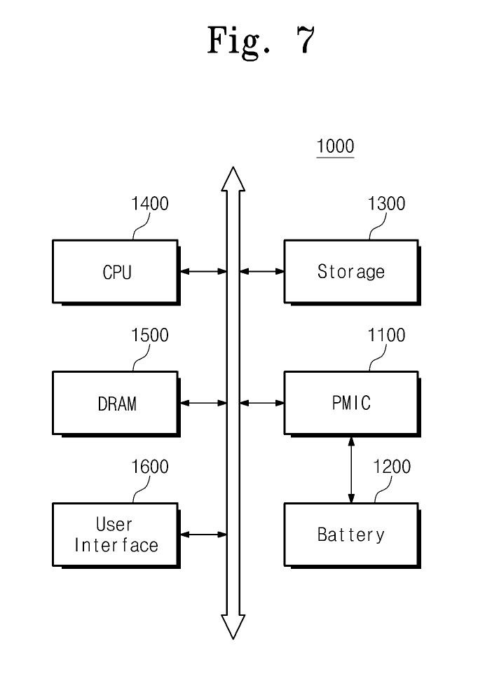

FIG. 7 is a block diagram schematically illustrating an electronic device including a power management integrated circuit according to example embodiments of the inventive concepts. Herein, an electronic device 1000 may be a personal computer or a handheld electronic device such as a notebook computer, a smart phone, a PDA, a camera, or the like.

Referring to FIG. 7, the electronic device 1000 may include a power management integrated circuit 1100, a battery 1200, a storage device 1300, a CPU 1400, a DRAM 1500, and a user interface 1600.

The power management integrated circuit 1100 may have the same structure and operation as any of the PMICs 100, 200 and 300 discussed above with reference to FIGS. 1-6. As described above, the electronic device 1000 may be configured to compress and store data necessary for booting of the power management integrated circuit 1100. The electronic device 1000 may be configured to decompress and use compressed code data in hardware. The power management integrated circuit 1100 may have a small size and a reduced operating time. Thus, a size of the electronic device 1000 may be scaled down, and a booting time may be shortened.

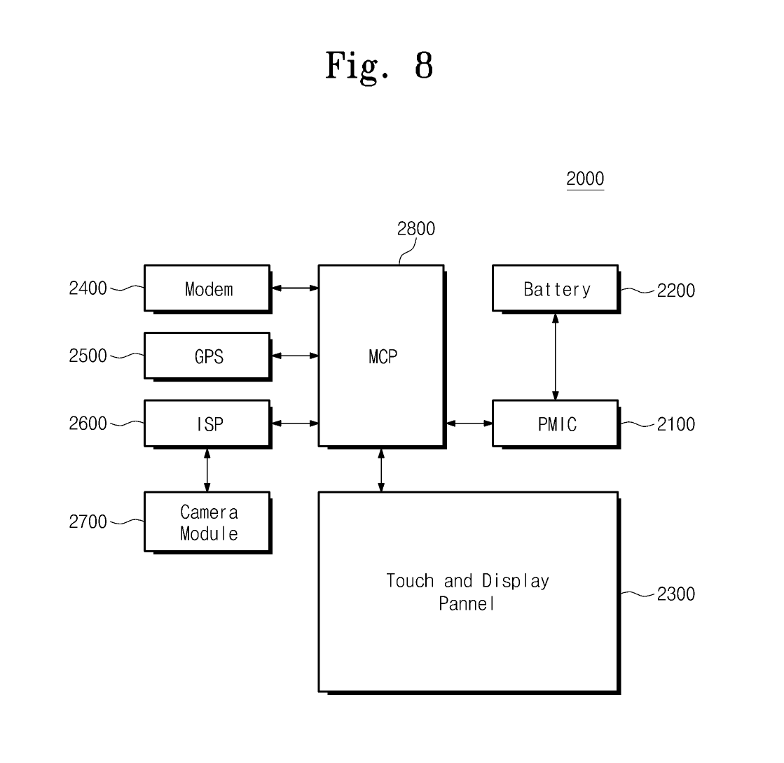

FIG. 8 is a block diagram schematically illustrating a smart phone including a power management integrated circuit according to example embodiments of the inventive concepts. Referring to FIG. 8, a smart phone 2000 may include a power management integrated circuit 2100, a battery 2200, a touch and display panel 2300, a modem 2400, a GPS 2500, an ISP (Image Signal Processor) 2600, a camera module 2700, and an MCP (Multi Chip Package) 2800.

The power management integrated circuit 2100 may have the same structure and operation as any of the PMICs 100, 200 and 300 discussed above with reference to FIGS. 1-6.

The touch and display panel 2300 may include a display panel for displaying an image and a touch panel for sensing a touch of a user. The touch panel may include a capacitive sensor.

The modem 2400 may be connected with a cellular network base station such as GSM (Global System for Mobile Communications), UMTS (Universal Mobile Telephone System), WCDMA (Wideband Code Division Multiple Access), or the like.

The modem 2400 may perform transmission and reception on voice and data communications.

The GPS 2500 may process a GPS signal input from a satellite.

The ISP 2600 may convert a light signal input from an image sensor in the camera module 2700 into digital data. The ISP 2600 may transfer the digital data to the MCP 2800.

The MCP 2800 may be a central processing unit controlling the smart phone 2000. The MCP 2800 may include an application processor (AP).

The power management integrated circuit 2100 may be connected with the battery 2200. The power management integrated circuit 2100 may control a power supplied to the smart phone 2000. The power management integrated circuit 2100 may compress and use data for booting. The power management integrated circuit 2100 may be configured to decompress and use compressed code data in hardware. The power management integrated circuit 2100 may have a small size and a reduced operating time. Thus, a size of the smart phone 2000 may be scaled down, and a booting time may be shortened.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A power management integrated circuit comprising:
a nonvolatile memory configured to store code data for driving the power management integrated circuit;
a processor configured to execute program data stored at a volatile memory; and
a decompression logic separated from the processor, the decompression logic being formed of hardware, configured to decompress the code data to generate program data, and configured to store the program data at the volatile memory.

2. The power management integrated circuit of claim 1, wherein,
the decompression logic is configured to determine whether the code data is compressed, and to decompress the code data according to a determination result, and
the code data includes header data indicating whether the code data is compressed.

3. The power management integrated circuit of claim 2, wherein the decompression logic comprises:
a compression check unit configured to determine whether the code data is compressed, based on the header data;
a packet check unit configured to determine whether a packet in the code data is compressed;
a packet decompression unit configured to decompress the packet when the packet is determined to be compressed; and
a buffer connected with the compression check unit, the packet check unit, and the packet decompression unit and configured to store data.

4. The power management integrated circuit of claim 3, wherein the compression check unit is configured to determine the code data to be uncompressed code data when the header data is ‘0’.

5. The power management integrated circuit of claim 3, wherein the decompression logic is configured such that if the code data is determined to be uncompressed code data, the compression check unit stores the code data at the buffer without decompression.

6. The power management integrated circuit of claim 3, wherein the packet includes a flag bit indicating whether the packet is compressed.

7. The power management integrated circuit of claim 6, wherein if the flag bit is 0, the packet check unit determines the packet to be an uncompressed packet.

8. The power management integrated circuit of claim 3, wherein the decompression logic is configured such that if the packet is determined to be an uncompressed packet, the packet check unit stores the packet at the buffer without decompression.

9. The power management integrated circuit of claim 3, wherein the code data is compressed in a dictionary reference manner.

10. The power management integrated circuit of claim 9, wherein the packet decompression unit is configured to,
identify a dictionary address and a match length from the packet,
generate a physical address using the dictionary address and the match length, and
decompress the packet based on the physical address.

11. The power management integrated circuit of claim 1, wherein the nonvolatile memory comprises:
a nonvolatile memory storage unit configured to store data; and
a nonvolatile memory controller configured to control a data processing operation of the nonvolatile memory storage unit,
wherein the decompression logic is included in the nonvolatile memory controller.

12. The power management integrated circuit of claim 1, wherein the volatile memory comprises:
a volatile memory storage unit configured to store data; and
a volatile memory controller configured to control a data processing operation of the volatile memory storage unit,
wherein the decompression logic is included in the volatile memory controller.

13. A driving method of a power management integrated circuit which includes a nonvolatile memory storing code data, a processor for executing program data, and decompression logic separated from the processor and formed of hardware, the driving method comprising:
providing the code data to the decompression logic from the nonvolatile memory when the code data is requested by the processor;
determining whether the code data is compressed; and
if the code data is compressed,
decompressing the code data to generate the program data, and
storing the program data at a volatile memory.

14. The driving method of claim 13, further comprising:
if the code data is determined not to be compressed, storing the code data at the volatile memory as the program data.

15. The driving method of claim 13, wherein the decompressing the code data to generate program data comprises:
decompressing the code data by the packet.

16. A power management integrated circuit comprising:
a nonvolatile memory storing encoded data that, when decoded, includes program data including executable instructions for driving the power management integrated circuit;
a hardwired decompression logic configured to decompress the encoded data to generate the program data and to store the program data at the volatile memory; and
a processor configured to execute program data stored at a volatile memory, the hardwired decompression logic being separate from the processor.

17. The power management integrated circuit of claim 16, wherein the hardwired decompression logic comprises:
a decompression unit configured to decompress the encoded data; and
a buffer connected with the decompression unit and configured to store the decompressed data.
